(19) United States
(12) Patent Application Publication
(10) Pub. No.: US 2025/0113838 A1
(43) Pub. Date: Apr. 10, 2025

(54) COTTON CANDY MACHINE WITH ENHANCED SAFETY

(71) Applicant: PS Gems LLC, New York, NY (US)

(72) Inventor: Tzvi Goldberg, Lakewood, NJ (US)

(21) Appl. No.: 18/908,762

(22) Filed: Oct. 7, 2024

Related U.S. Application Data
(60) Provisional application No. 63/542,733, filed on Oct. 5, 2023.

(51) Int. Cl. A23G 3/10

(52) U.S. Cl. CPC A23G 3/10

(57) ABSTRACT

A cotton candy machine having improved safety. The cotton candy machine is provided with a rotating chamber for receiving floss and a heating element disposed below the rotating chamber. A wall extends downwardly from the rotating chamber past the heating element, thereby serving as a physical barrier preventing floss from contacting the heating element. The cotton candy machine also is provided with an air exchange system whereby a series of opening proximate to the heating element allows for release of hot air from the interior of the unit and inflow of cooler air from the exterior of the unit.

### RELATED APPLICATIONS

This application claims the benefit of pending Prov. Appl. 63/542,733 filed Oct. 5, 2023, the contents of which are incorporated by reference herein.

### FIELD OF THE INVENTION

The invention relates to the field of cotton candy machines, more particularly to a cotton candy machine having improved safety features.

### BACKGROUND OF THE INVENTION

Cotton candy machines are popular confectionary devices used at parties, celebrations and increasingly in homes. Cotton candy is generated by heating floss in a rotating chamber. Thus, basic machine constructions include a rotating chamber driven by a shaft connected to an electric motor. An electric heating element in proximity to the rotating chamber heats the floss to a sufficient melting point so that it forms a string like shape. In many cotton candy machine designs, errant floss can be thrust into contact with the machine's heating element, thereby causing a fire danger.

### SUMMARY OF THE INVENTION

Embodiments of the invention provide a cotton candy machine having a protective collar surrounding the heating element, thereby preventing floss from contacting the heating element. Embodiments of the invention further provide a heat escape zone formed of vents to facilitate cooling of the machine interior.

### BRIEF DESCRIPTION OF THE FIGURES

FIG. 1 is a perspective view of a cotton candy machine base in accordance with an embodiment of the invention.

FIG. 2 is an exploded view of a cotton candy machine in accordance with an embodiment of the invention.

FIG. 3 is a cross-sectional view through a cotton candy in accordance with an embodiment of the invention.

### DETAILED DESCRIPTION OF THE INVENTION

Embodiments of the present invention will now be described with reference to the above-identified figures of the drawings. However, the drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

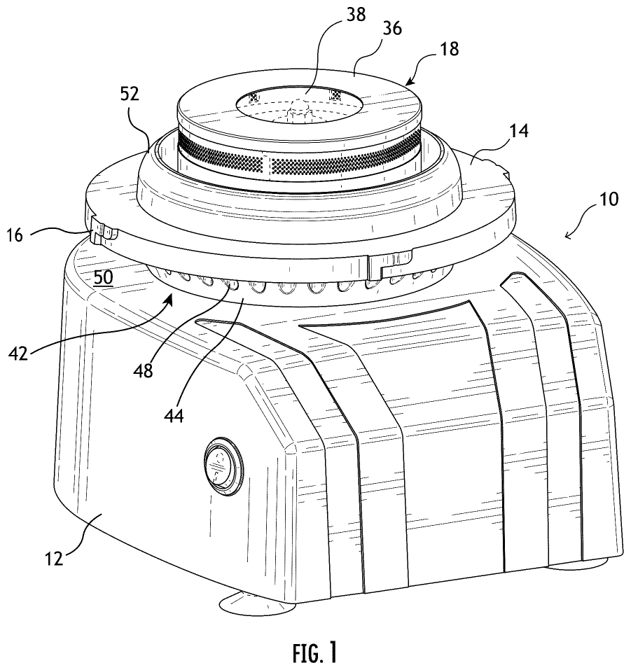

With reference to FIG. 1, a cotton candy machine base 10 is shown. Base 10 is formed of an outer housing 12 which encloses a motor and other mechanical elements. An upper segment of base 10 includes a bowl-interfacing surface, such as flange 14. Flange 14 is provided with barbs 16 or similar locking members that interlock with mating members on a cooperating bowl. Projecting upward from base 10 is a rotatable chamber 18 that is configured to receive granulated sugar (floss).

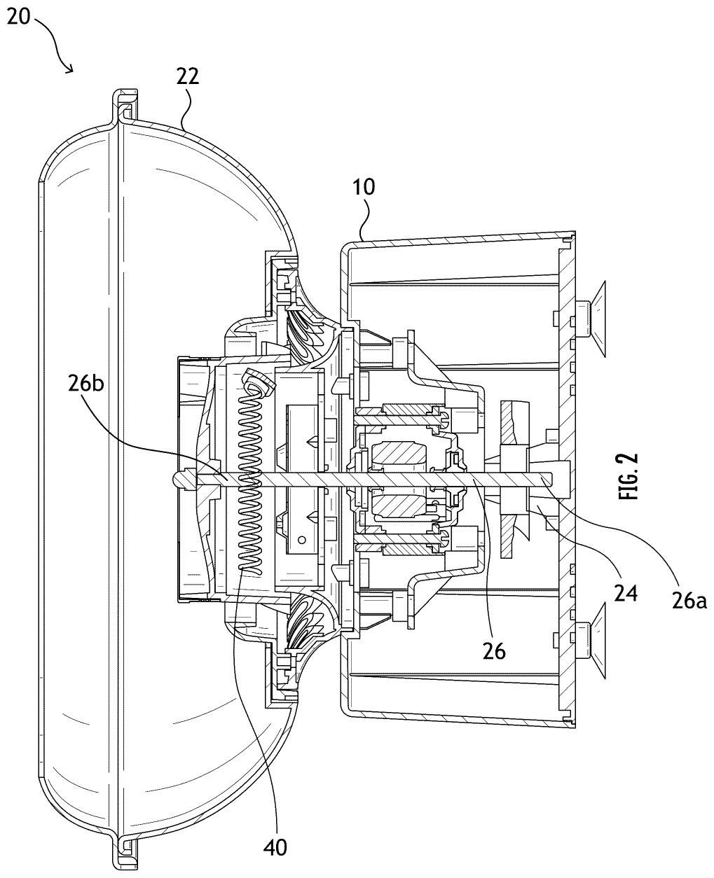

FIG. 2 shows a cross-sectional view of a cotton candy machine 20 shown with an accompanying bowl 22 installed on base 10.

With continued reference to FIG. 2, a motor 24 is mounted in housing 12. Motor 24 is connected to an electric source and optionally to a circuit board configured to control various functions. A rotatable shaft 26 is provided having a first end 26a connected to motor 24 and second end 26b connected to rotatable chamber 18.

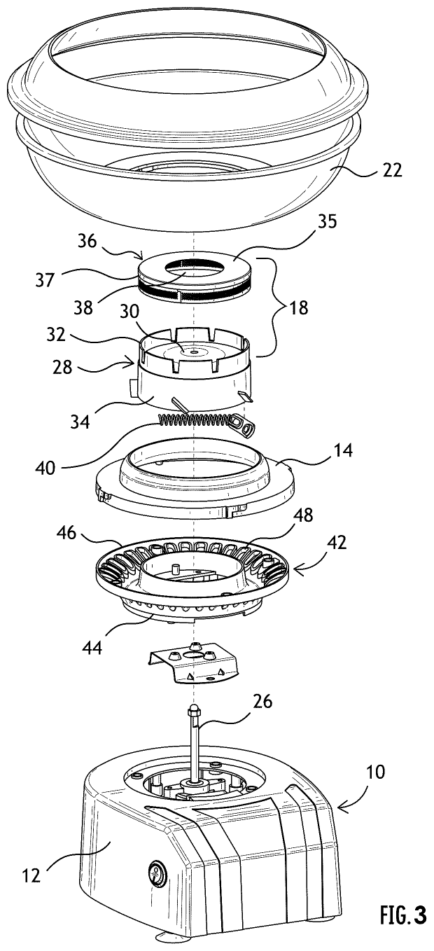

With reference to FIG. 3 rotatable chamber 18 is shown as being formed of a lower part 28 and cover 36. Lower part 28 has an integral plate 30 in its center. Plate 30 has an upper surface (shown) and an underside surface. A rounded wall 32 extends upwardly from plate 30 and a lower collar 34 projects downwardly from plate 30. Cover 36 is a disc-shaped lid having a flat surface 35 with an opening 38 in its center. A lower surrounding wall 37 extends downwardly from flat surface 35. In embodiments of the invention, surrounding wall 37 is provided with small holes, a screen or similar vents. Cover 36 is installed atop lower part 28. Flat surface 35 of cover 36 has an upper surface (shown) and underside surface.

In embodiment of the invention a chamber is formed by upper surface of plate 30, inward surfaces of rounded wall 32, and underside surface of flat surface 35 of cover 36. The chamber is configured to receive floss or any such similarly granulated product.

In embodiments of the invention, an opening in the center of plate 30 is connected to second end 26b of rotatable shaft 26, such that rotatable chamber 18 rotates with the corresponding rotation of rotatable shaft 26.

In embodiments of the invention, a heating element 40 is disposed below the underside of plate 30. Heating element 40 imparts sufficient heat to warm the plate 30 in order to cause desired melting of sugar granules.

In embodiments of the invention, collar 34 of lower part 28 is formed of a wall of sufficient height to descend downwardly from plate 30 such that it terminates in a plane that is lower than a plane in which heating element 40 is positioned. In embodiments of the invention, In this regard, collar 34 serves as a physical barrier surrounding heating element 40 such that any misdirected or errant sugar granules will be blocked by collar 34 from traversing into heating element 40.

In some embodiments of the invention, collar 34 extends downwardly a sufficient distance to surround the majority of the heating element 40.

In embodiments of the invention, a heat dissipation system is provided to allow efficient heat passage from the interior of base and the inflow of cooler air from outside the base. In this regard, in embodiments of the invention, a flange lower part 42 is disposed on the underside of flange 14. As shown, flange lower part 42 has an inner ring portion 44 that extends upwardly and outwardly terminating in larger outer ring 46. A series of openings 48 are made in flange lower part 42, which serve as vents allowing for air exchange into the interior of base 12. In embodiment of the invention, flange lower part 42 is disposed in proximity to heating element 40, thereby allowing for efficient heat dissipation from the unit.

It will be understood that flange 14 is a solid ring that overlies the openings 48 of flange lower part 42 thereby preventing any dirt, sugar or the like from entering in the openings 48.

Returning to FIG. 1, base is shown having a housing, preferably formed of plastic material. As shown, sidewalls of base 10 rise and terminate in a flat horizontal wall 50. Flange lower part 42 is shown extending upwardly from wall 50, and flange 14 is shown mated with flange lower part 42. A raised circular wall 52 is disposed on flange 14. As further shown, cover 36 of rotatable chamber 18 emerges from housing 12 of base.

In use, a user inserts granulated sugar through opening 38 and into rotatable chamber 18. The combined heat and spinning momentum of rotating chamber 18 causes melted sugar to form into elongated candy strands, which exit the rotatable chamber to form cotton candy.

As described, in the event that a user accidentally spills sugar outside of the rotating chamber, it will be blocked by collar 34 from contacting the heating element 40—thereby preventing unintended burning.

While this invention has been described in conjunction with the embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A cotton candy machine, comprising:
a base;
a motor;
a shaft having a first end and a second end, the first end of the shaft in communication with the motor;
a rotating chamber comprising:
a plate having an upper surface and an underside surface
a rounded wall extending upwardly from the plate, and
a cover having a central opening applied atop the rounded wall;
a heating element disposed below the underside surface of the plate;
a collar extending downwardly from the rotating chamber and surrounding the heating element; and
the second end of the shaft connected to the rotating chamber to impart rotational force to the rotating chamber.

2. The cotton candy machine of claim 1, whereby the cover comprises sidewalls having openings.

3. The cotton candy machine of claim 1, further comprising an outer housing;

4. The cotton candy machine of claim 1, wherein the base comprises a ring portion having a series of openings configured to allow air exchange between the outside of the base and the interior of the base.

5. The cotton candy machine of claim 4, whereby the ring portion comprises a lower segment and an upper segment.
